(19) United States
(12) Patent Application Publication
(10) Pub. No.: US 2023/0151202 A1
(43) Pub. Date: May 18, 2023

(54) THERMOPLASTIC ELASTOMER, COMPOSITION, AND MOLDED PRODUCT

(71) Applicant: ASAHI KASEI KABUSHIKI KAISHA, Chiyoda-ku, Tokyo (JP)

(72) Inventors: Jun SUZUKI, Chiyoda-ku, Tokyo (JP); Hitoshi MIZOMOTO, Chiyoda-ku, Tokyo (JP); Masami YONEMURA, Chiyoda-ku, Tokyo (JP)

(73) Assignee: ASAHI KASEI KABUSHIKI KAISHA, Chiyoda-ku, Tokyo (JP)

(21) Appl. No.: 17/906,747

(22) PCT Filed: Mar. 24, 2021
(86) PCT No.: PCT/JP2021/012408

§ 371 Date: Sep. 20, 2022

(30) Foreign Application Priority Data
Mar. 27, 2020 (JP) 2020-058692
Apr. 7, 2020 (JP) 2020-068979

(51) Int. Cl. C08L 53/02

(52) U.S. Cl. CPC C08L 53/025; C08L 2207/04; C08L 2201/50; C08L 2201/52

(57) ABSTRACT

It could be helpful to provide a thermoplastic elastomer excellent in transparency, etc., while having mechanical properties such as high heat resistance, strength, and flexibility. The thermoplastic elastomer of this disclosure primarily comprises a copolymer including a block structural unit derived from a polymer (A) that contains a polyphenylene ether and has a glass transition temperature of 120° C. or more, and a block structural unit derived from a polymer (B) that primarily contains a diene rubber and has a glass transition temperature of 20° C. or less.

### TECHNICAL FIELD

The present disclosure relates to a thermoplastic elastomer, a composition, and a molded product.

### BACKGROUND

Copolymers having constitutional units exhibiting high heat resistance and strength, such as crystalline aromatic polyester units and polyamide units, as hard segments, and aliphatic polyether units such as poly(alkylene oxide) glycol and/or aliphatic polyester units such as polylactone as soft segments are excellent in mechanical properties such as strength, impact resistance, elastic recovery, and flexibility, and low-temperature and high-temperature properties, and are further thermoplastic to be easy for molding process, thus being widely used for automotive components and industrial materials.

However, in general, the copolymers as described above are limited in materials that constitute the hard segments/the soft segments due to the solubility and reactivity of the raw materials under the current conditions. As copolymers of hard segments and soft segments having high heat resistance, copolymers of crystalline polymer, such as polyester elastomer (PTL 1) or polyamide elastomer (PTL 2), and polyether are generally known, but such resins have problems with flame retardance and transparency.

A copolymer of polyphenylene ether and polybutadiene (PTL 3) is also reported, but it is a random copolymer and has problems such as insufficient transparency and too higher glass transition temperature compared to the raw material, affecting the melt processability.

### CITATION LIST

### Patent Literature

PTL 1: JPH03229752A

PTL 2: JP5369683B2

PTL 3: WO2019203112A

### SUMMARY

### Technical Problem

The present disclosure is made based on consideration on the aforementioned points, and it could be helpful to provide a thermoplastic elastomer excellent in transparency while having mechanical properties such as high heat resistance, strength, and stretch.

### Solution to Problem

Specifically, this disclosure provides the following.

[1] A thermoplastic elastomer primarily comprising a copolymer including a block structural unit derived from a polymer (A) that contains a polyphenylene ether and has a glass transition temperature of 120° C. or more, and a block structural unit derived from a polymer (B) that primarily contains a diene rubber and has a glass transition temperature of 20° C. or less.

[2] The thermoplastic elastomer according to [1], wherein the copolymer is an ABA copolymer having a block array structure of the block structural unit derived from the polymer (A), the block structural unit derived from the polymer (B), and the block structural unit derived from the polymer (A).

[3] The thermoplastic elastomer according to [1] or [2], wherein the copolymer has a block array structure in which the block structural unit derived from the polymer (A) and the block structural unit derived from the polymer (B) are alternately arrayed.

[4] The thermoplastic elastomer according to any one of [1] to [3], wherein the polymer (A) is a polyphenylene ether having a phenolic hydroxyl group at one end.

[5] The thermoplastic elastomer according to any one of [1] to [3], wherein the polymer (A) is a polyphenylene ether having a phenolic hydroxyl group at both ends.

[6] The thermoplastic elastomer according to any one of [1] to [3], wherein the polymer (A) is a polyphenylene ether having an isocyanate group at both ends. [7] The thermoplastic elastomer according to any one of [1] to [6], wherein the polymer (B) is a diene rubber having an isocyanate group at both ends.

[8] The thermoplastic elastomer according to any one of [1] to [7], wherein the diene rubber is a hydrogenated polybutadiene rubber.

[9] The thermoplastic elastomer according to any one of [1] to [8], wherein the copolymer is a copolymer in which the block structural unit derived from the polymer (A) is bonded to the block structural unit derived from the polymer (B) via a urethane bond. [10] A thermoplastic elastomer resin composition comprising the thermoplastic elastomer according to any one of [1] to [9].

A molded product comprising the thermoplastic elastomer resin composition according to [10].

### Advantageous Effect

In accordance with the present disclosure, as described below, it is possible to obtain a thermoplastic elastomer excellent in transparency while having mechanical properties such as high heat resistance, strength, and stretch.

### DETAILED DESCRIPTION

In the following, an embodiment for embodying the present disclosure (hereinafter, referred to as “the present embodiment”) will be described in detail. The present disclosure is not limited to only the following embodiment and may be implemented with a wide variety of modifications without departing from the scope thereof.

The following term definitions are applied throughout the present specification and claims.

“Thermoplasticity” means a property of softening by being heated to a glass transition temperature or a melting point or more. The softening easily allows the molding process.

“Copolymerization” means synthesizing polymers from two or more different raw materials.

“Alternately arraying” means an array having a structure in which different structures (A) and (B) are repeated in order such as (A), (B), (A), and (B).

“Glass transition temperature” means a temperature measured using a differential scanning calorimeter (DSC) in a method described in the EXAMPLES section below.

[Thermoplastic Elastomer]

A thermoplastic elastomer of the present embodiment is a thermoplastic elastomer primarily comprising a copolymer including a block structural unit derived from a polymer (A) containing a polyphenylene ether and having a glass transition temperature of 120° C. or more and a block structural unit derived from a polymer (B) primarily containing a diene rubber and having a glass transition temperature of 20° C. or less such that the polymer (A) and the polymer (B) are copolymerized.

The aforementioned thermoplastic elastomer may be a thermoplastic elastomer constituted only from the aforementioned copolymer or may further contain other components.

The aforementioned copolymer includes the block structural unit derived from the polymer (A) containing a polyphenylene ether and has a glass transition temperature of 120° C. or more (also referred to simply as “block structural unit (A)” herein) and the block structural unit derived from the polymer (B) primarily containing a diene rubber and has a glass transition temperature of 20° C. or less (also referred to simply as “block structural unit (B)” herein), and is preferably constituted only from the block structural unit (A) and the block structural unit (B).

The copolymer may include other structural units in addition to the block structural unit (A) and the block structural unit (B).

(Polymer (A))

The polymer (A) includes a structural unit derived from a polyphenylene ether, and is preferably constituted only from the structural unit derived from a polyphenylene ether. The polymer (A) may include other structural units in addition to the structural unit derived from a polyphenylene ether.

The polymer (A) preferably has a phenolic hydroxyl group at both ends, and is more preferably a polyphenylene ether having a phenolic hydroxyl group at both ends.

The polymer (A) preferably has a phenolic hydroxyl group at one end, and is more preferably a polyphenylene ether having a phenolic hydroxyl group at one end.

The polymer (A) preferably has an isocyanate group at both ends, and is more preferably a polyphenylene ether having an isocyanate group at both ends.

The polymer having an isocyanate group at the end can be obtained, for example, by modifying a hydroxyl group at the end of the polymer with diisocyanate such as tolylene diisocyanate and diphenylmethane diisocyanate. Next, this polymer may react with the polymer (B) having a hydroxyl group at the end to obtain a copolymer. The isocyanate modification at the end may be performed at one end or both ends of the polymer (A). Particularly, the phenolic hydroxyl group at the end of the polymer (A) has low reactivity. Thus, by modifying both ends of the high molecular weight body (A) with diisocyanate and then reacting it with the polymer (B), a copolymer with a higher molecular weight is obtained.

As the aforementioned diisocyanate, any diisocyanate such as tolylene diisocyanate and diphenylmethane diisocyanate may be used. However, the reaction between diisocyanate and the polymer having a hydroxyl group at both ends makes it difficult for the subsequent copolymerization reaction to proceed because the polymer having both ends to be modified partially polymerizes alone to be insolubilized by having a high molecular weight. Accordingly, in consideration for the aforementioned points, the reactivities of respective isocyanate groups in the diisocyanate compound are preferably different, and in particular, tolylene diisocyanate is preferably used.

—Structural Unit Derived from Polyphenylene Ether—

As the aforementioned polyphenylene ether, a polymer including a repeating unit represented by the following formulae (I) and/or (II) is preferable, and a polymer constituted by repeating the repeating unit represented by the following formulae (I) and/or (II) is more preferable. The polyphenylene ether may be a homopolymer or a copolymer:

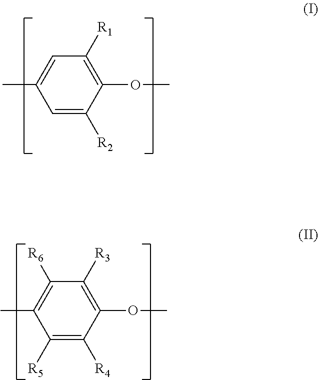

(In the above formulae (I) and (II), R₁, R₂, R₃, R₄, R₅, and R₆ are each independently a hydrogen atom, a halogen atom, an alkyl group having a carbon number of 1 to 4, or an aryl group having a carbon number of 6 to 12. However, R₅ and R₆ are not hydrogen atoms at the same time.)

The structural unit derived from a polyphenylene ether included in the polymer (A) may be one type or a plurality of types.

The homopolymer of the polyphenylene ether includes, for example, poly(2,6-dimethyl-1,4-phenylene)ether, poly(2-methyl-6-ethyl-1,4-phenylene)ether, poly(2,6-diethyl-1,4-phenylene)ether, poly(2-ethyl-6-n-propyl-1,4-phenylene)ether, poly(2,6-di-n-propyl-1,4-phenylene)ether, poly(2-methyl-6-n-butyl-1,4-phenylene)ether, poly(2-ethyl-6-isopropyl-1,4-phenylene)ether, poly(2-methyl-6-chloroethyl-1,4-phenylene)ether, poly(2-methyl-6-hydroxyethyl-1,4-phenylene)ether, and poly(2-methyl-6-chloroethyl-1,4-phenylene)ether. Among them, from the viewpoint of easiness to obtain materials and the price, poly(2,6-dimethyl-1,4-phenylene)ether is preferable.

The aforementioned copolymer of the polyphenylene ether is a copolymer with the repeating unit represented by the above formulae (I) and/or (II) as the primary structural unit, and also may be a copolymer constituted only from the repeating unit represented by the above formulae (I) and/or (II). Here, the primary structural unit means that the mass ratio of this structural unit is above 70% by mass per 100% by mass of the copolymer.

Specific examples of the copolymer include, for example, a copolymer of 2,6-dimethylphenol and 2,3,6-trimethylphenol; a copolymer of 2,6-dimethylphenol and o-cresol; and a (ternary) copolymer of 2,6-dimethylphenol, 2,3,6-trimethylphenol, and o-cresol.

Both ends of the polymer (A) are preferably phenolic hydroxyl groups of the structural unit derived from the aforementioned polyphenylene ether.

The mass ratio of the structural unit derived from a polyphenylene ether in the polymer (A) is preferably 90% by mass or more.

—Other Structural Units—

Other structural units included in the polymer (A) include, for example, a structural unit derived from a compound having two phenolic hydroxyl groups such as a compound represented by the following formula (III):

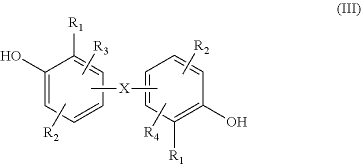

(In formula (III), R₁, R₂, R₃, and R₄ are each independently selected from the group consisting of a hydrogen atom, a halogen atom, an alkyl group having a carbon number of 1 to 7, a phenyl group, a haloalkyl group, an aminoalkyl group, a hydrocarbon oxy group, and a halo-hydrocarbon oxy group in which a halogen atom and an oxygen atom are separated by at least two carbon atoms, and X is selected from the group consisting of a single bond, a divalent hetero atom, and a bivalent hydrocarbon group having a carbon number of 1 to 12 which may be substituted with an aromatic or aliphatic hydrocarbon having a carbon number of 1 to 6.)

The compound represented by the above formula (III) includes, for example, bisphenol A, tetramethylbisphenol A (that is, 2,2-bis(3,5-dimethyl-4-hydroxyphenyl)propane), bisphenol B, and 4,4′-biphenol.

The aforementioned compound having two phenolic hydroxyl groups may be included in the polymer (A), for example, as a divalent linking group with a hydrogen atom removed from each phenolic hydroxyl group. For example, the linking group may be linked with the aforementioned structural unit derived from a polyphenylene ether.

The polymer (A) may be a polymer in which the aforementioned other structural unit is sandwiched between the two aforementioned structural units derived from a polyphenylene ether, and both ends are phenolic hydroxyl groups of each polyphenylene ether. This polymer may be, for example, a compound represented by the following formula (IV):

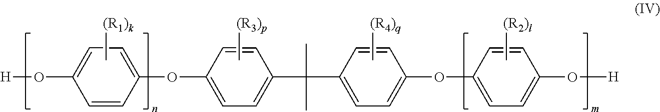

(In formula (IV), R₁ and R₂ each independently represent a hydrogen atom, a halogen atom, an alkyl group having a carbon number of 1 to 4, or an aryl group having a carbon number of 6 to 12. R₃ and R₄ each independently represent a hydrogen atom, a halogen atom, an alkyl group having a carbon number of 1 to 7, a phenyl group, a haloalkyl group, an aminoalkyl group, a hydrocarbon oxy group, or a halo-hydrocarbon oxy group in which a halogen atom and an oxygen atom are separated by at least two carbon atoms. k, l, p, and q each independently represent an integer of 1 to 4. n and m represent the numbers of repeating units, and each independently represent an integer of 1 to 1000.)

For the molecular weight of the polymer (A), polymers having a number average molecular weight of one thousand to a few hundred thousand are available. However, polymers having a number average molecular weight of 20,000 or less are preferable as the raw materials for the thermoplastic elastomer of the present embodiment. The weight-average molecular weight of the polymer (A) is preferably 1,000 to 40,000.

The number average molecular weight and weight-average molecular weight mean herein values calculated by polystyrene conversion, based on the measurement result of gel permeation chromatography.

The glass transition temperature of the polymer (A) is, from the viewpoint that the thermoplastic elastomer exhibits the heat resistance, 120° C. or more, preferably 130 to 230° C., and more preferably 140 to 220° C.

The polymer (A) can be synthesized, for example, according to the method of JP2019189686A.

(Polymer (B))

The polymer (B) may be a polymer primarily including a diene rubber such as a butadiene rubber and a hydrogenated butadiene rubber, a butyl rubber, an ethylene-propylene rubber, a silicon rubber, a nitrile rubber, a chloroprene rubber, an acrylic rubber, polyether, or polyolefin. Among them, from the viewpoint of being less likely to be degraded by heat and oxygen and excellence in flexibility, the diene rubber is preferable, the butadiene rubber and the hydrogenated butadiene rubber such as hydrogenated polybutadiene are more preferable, and the hydrogenated butadiene rubber is further preferable.

“Primarily including” means that the mass ratio of the structure is 60% by mass or more, preferably 80% by mass or more, and more preferably 90% by mass or more per 100% by mass of the polymer (B), and it is particularly preferred to account for the entire polymer (B) excluding the functional group introduced at both ends.

For the molecular weight of the polymer (B), polymers having a number average molecular weight of a few hundred to a few hundred thousand are available. However, polymers having a number average molecular weight of 500 to 20,000 are preferable, and polymers having a number average molecular weight of 1,000 to 10,000 are particularly preferable, as the raw materials for the thermoplastic elastomer of the present embodiment. The weight-average molecular weight of the polymer (B) is preferably 700 to 30,000.

The glass transition temperature of the polymer (B) is, from the viewpoint that the thermoplastic elastomer exhibits rubber properties such as stretch, preferably 20° C. or less, more preferably −80 to 0° C., and further preferably −70 to −10° C.

In the polymer (B), any of both ends is preferably modified with a functional group with high reactivity. The functional group is preferably an isocyanate group, an acid anhydride, or a glycidyl group. Among them, for ease of end modification, the isocyanate group is particularly preferable.

The polymer having an isocyanate group at the end can be obtained, for example, by modifying a hydroxyl group at the end of the polymer (B) with diisocyanate such as tolylene diisocyanate and diphenylmethane diisocyanate. Next, it may react with the polymer (A) having a hydroxyl group at the end to obtain a copolymer.

The isocyanate modification at the end may be performed at one end or both ends of the polymer (B). Particularly, the phenolic hydroxyl group of the high molecular weight body (A) has low reactivity. Thus, by modifying both ends of the high molecular weight body (B) with diisocyanate and then reacting it with the polymer (A), a polymer with a higher molecular weight can be obtained.

The aforementioned diisocyanate includes, for example, tolylene diisocyanate and diphenylmethane diisocyanate. The reaction between diisocyanate and the polymer having a hydroxyl group at both ends makes it difficult for the subsequent copolymerization reaction to proceed because the polymer having both ends to be modified partially polymerizes alone to be insolubilized by having a high molecular weight. Accordingly, in consideration for the aforementioned points, the reactivities of respective isocyanate groups in the diisocyanate compound are preferably different, and in particular, tolylene diisocyanate is preferably used.

The polymer (B) may further include other structural units. The other structural units are not particularly limited as long as a structural unit that can be copolymerized with the primarily included structural unit.

The other structural unit other than the block structural unit (A) and the block structural unit (B) in the aforementioned copolymer may be a block structural unit or a structural unit derived from a monomer component. The copolymer is preferably a block copolymer constituted only from the block structural units.

The other structural units are not particularly limited, and include a structural unit derived from a known monomer component used for the thermoplastic elastomer.

In the aforementioned copolymer, the other structural unit derived from the other component is preferably included in the part other than the structural unit derived from the polymer (A) and the structural unit derived from the polymer (B) (preferably, the part other than the structure in which the block structural unit (A) and the block structural unit (B) are alternately arrayed).

The aforementioned copolymer preferably has a structure in which the polymer (A) and the polymer (B) are copolymerized, and the block structural unit (A) and the block structural unit (B) are alternately arrayed (also referred to as “alternate structure” herein), that is, a tandem repeating structure as (A)-(B)-(A)-(B) . . . . By including the alternate structure, the transparency is more excellent, and the flexibility such as stretch is more excellent while having the heat resistance and the strength.

The copolymer preferably includes an alternate structure in which the block structural unit (A) and the block structural unit (B) are alternately arrayed, more preferably includes a repeating structure of at least (B)-(A)-(B) or (A)-(B)-(A), and is further preferably constituted only from the repeating structure.

The part other than the alternate structure includes, for example, a structure including the other structural unit derived from the other component.

The block structural unit (A) is preferably bonded to the block structural unit (B) via a urethane bond. This can make the bonding part between the polymers strong to obtain the thermoplastic elastomer that exhibits excellent strength.

The aforementioned copolymer is preferably a compound represented by the following formula (V) or (V′):

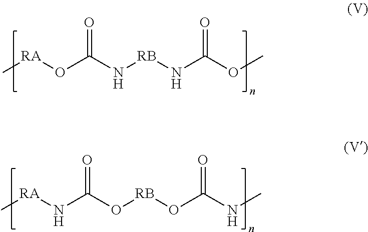

in formulae (V) and (V′), RA represents the polymer (A), and RB represents the polymer (B).

In the aforementioned copolymer, the total mass ratio of the block structural unit derived from the polymer (A) and the block structural unit derived from the polymer (B) is, from the viewpoint of excellence in properties such as the heat resistance and the stretch, preferably 80% by mass or more, more preferably 90% by mass or more, further preferably 95% by mass or more, and particularly preferably 100% by mass.

In the copolymer, the mass ratio of the alternate structure is, from the viewpoint of the heat resistance and the transparency, preferably 80% by mass or more, more preferably 90% by mass or more, further preferably 95% by mass or more, and particularly preferably 100% by mass.

In manufacturing the aforementioned copolymer, the ratio of additive amounts of the polymer (A) and the polymer (B) is not particularly limited. The polymer (B) having a mol number larger than that of the polymer (A) may be used, the polymer (A) having a mol number larger than that of the polymer (B) may be used, or the polymer (A) and the polymer (B) having an equal mol number may be used. Particularly, the polymer (A) and the polymer (B) preferably have an equal mol number. The polymer (A) and the polymer (B) having an equal mol number can obtain a thermoplastic elastomer more excellent in heat resistance and strength, without remaining the polymer (A) and the polymer (B) after the reaction.

The aforementioned thermoplastic elastomer primarily includes the aforementioned copolymer. The mass ratio of the copolymer per 100% by mass of the thermoplastic elastomer is preferably 80% by mass or more, more preferably 90% by mass or more, further preferably 95% by mass or more, and particularly preferably 100% by mass.

Other components other than the copolymer included in the thermoplastic elastomer include, for example, the polymer (A) and/or the polymer (B) that were not copolymerized, and a solvent and a catalyst that were used for the copolymerization.

The thermoplastic elastomer of the present embodiment preferably has a glass transition temperature. The glass transition temperature of the thermoplastic elastomer is, from the viewpoint of excellence in heat resistance, preferably 120° C. or more. The glass transition temperature of the thermoplastic elastomer of the present embodiment is preferably near the glass transition temperature of the polymer (A), preferably within ±30° C. of the glass transition temperature of the polymer (A), more preferably within ±20° C. of the glass transition temperature of the polymer (A), and further preferably within ±10° C. of the glass transition temperature of the polymer (A).

In the thermoplastic elastomer of the present embodiment, in the molecular weight measurement with the gel permeation chromatography, the number average molecular weight calculated by polystyrene conversion is preferably 3,000 to 150,000, more preferably 4,000 to 100,000, and further preferably 5,000 to 80,000. The number average molecular weight being within the above ranges makes the thermoplastic elastomer be excellent in heat resistance and mechanical strength, have not too high viscosity, and be also excellent in molding processibility.

The weight-average molecular weight of the thermoplastic elastomer of the present embodiment is, from the viewpoint of the heat resistance, the mechanical strength, and the molding processibility, preferably 4,000 to 200,000, and more preferably 5,000 to 120,000.

The thermoplastic elastomer of the present embodiment can be obtained as a copolymer, for example, by uniformly dissolving the polymer (A) and the polymer (B) in a solvent and then reacting them under heating.

The solvent that can be used for copolymerization includes, for example, toluene, xylene, ethylbenzene, N-methylpyrrolidone, and dimethylformamide, and the combined solvent thereof may be used. Among them, toluene, which has a low boiling point and is easy to be removed after polymerization, is preferable.

The reaction temperature is 30° C. to 120° C., and preferably 40° C. to 110° C.

The reaction hour is preferably one hour to 30 hours.

The catalyst may be used to promote the copolymerization of the polymer (A) and the polymer (B). The catalyst includes, for example, triethylamine, tin ethylhexanoate, and dibutyltin dilaurate.

[Thermoplastic Elastomer Resin Composition]

A thermoplastic elastomer resin composition of the present embodiment includes the aforementioned thermoplastic elastomer of the present embodiment and may further include other additives. The thermoplastic elastomer resin composition may be constituted only from the thermoplastic elastomer.

The mass ratio of the thermoplastic elastomer in the thermoplastic elastomer resin composition is preferably 80% by mass or more, more preferably 90% by mass or more, and further preferably 97% by mass or more per the mass of the thermoplastic elastomer resin composition (100% by mass). The mass ratio of the aforementioned copolymer is preferably 80% by mass or more, more preferably 90% by mass or more, and further preferably 97% by mass or more per the mass of the thermoplastic elastomer resin composition (100% by mass).

(Other additives)

The aforementioned other additives include, for example, a lubricant, a plasticizer, a release agent, an antibacterial agent, a fungicide, a light stabilizer, a flame retardant, an ultraviolet absorber, a bluing agent, a dye, a pigment, an antistatic agent, a thermal stabilizer, a defoamer, and a dispersant.

The mass ratio of the other additives in the thermoplastic elastomer resin composition is preferably 3 parts by mass or less, and more preferably 1 part by mass or less per the mass of the thermoplastic elastomer (100 parts by mass). The lower mass ratio of the other additives is likely to make the obtained molded product express good properties.

[Molded Product]

A molded product of the present embodiment includes the thermoplastic elastomer resin composition of the aforementioned embodiment.

The molded product can be produced, for example, by molding the thermoplastic elastomer resin composition of the present embodiment. The method of producing the molded product includes, for example, a method of casting the kneaded aforementioned thermoplastic elastomer resin composition into a mold to mold it. The thermoplastic elastomer resin composition of the present embodiment can also be a laminated body by applying it on a base and drying it. The molded product can be used, for example, for automobile interior components, and enclosures of the home electric appliances.

### EXAMPLES

The following specifically describes this disclosure using examples, but this disclosure is not limited to these.

Evaluation methods used in each example, which is described later, are described below.

<Evaluation Method>

### (Tensile Test)

Tensile tests were conducted in the following conditions using ISO37 type 2 dumbbell specimens with a thickness of 2 mm.

Model: 5564 made by INSTRON
Tension rate: 50 mm/min
Distance between chucks: 25 mm
The strain and the maximum stress at the time when the specimen was broken were read.

(Glass Transition Temperature)

The glass transition temperatures of the polymer (A), the polymer (B), and the thermoplastic elastomer were measured in the following conditions.

Model: DSC3500 made by NETZSCH
Measurement condition: temperature change from −20 to 240° C. at 20 K/min in a nitrogen atmosphere
The data at the second scanning was read as a glass transition temperature.

(Weight-Average Molecular Weight, Number Average Molecular Weight)

The measurements were made in the following conditions using a gel permeation chromatography (GPC).

GPC model: HPLC-8320 made by Tosoh Corporation
Column: K-803L, K-806M made by Shodex
Mobile phase: chloroform 1.0 ml/min
Sample concentration: 0.2% by mass
Temperature: oven 40° C., inlet 35° C., detector 35° C.
Detector: differential refractometer
The molecular weight at each elution time was calculated using an elution curve of monodisperse polystyrene and calculated as a molecular weight in terms of polystyrene.

### Example 1

### (Synthesis of Polymer (A1))

In a 1.5-liter jacketed reactor equipped with a sparger for oxygen-containing gas introduction, a stirring turbine impeller, and a baffle at the reactor bottom, and a reflux condenser at a vent gas line of the reactor upper part, 0.2512 g of cupric chloride dihydrate, 1.1062 g of 35% hydrochloric acid, 9.5937 g of N,N,N′,N′-tetramethylpropanediamine, 213.0 g of n-butanol and 496.0 g of methanol, 122.8 g of 2,6-dimethylphenol, and 57.1 g of 2,2-bis(3,5-dimethyl-4-hydroxyphenyl)propane were added. The composition mass ratio of the used solvent was n-butanol:methanol=30:70. Next, at the same time as beginning to introduce oxygen into the reactor from the sparger at a rate of 180 mL/min while vigorously stirring it, the heating medium was passed through the jacket so as to keep the polymerization temperature at 45° C. for adjustment. The polymerization solution gradually took on the appearance of a slurry.

120 minutes later from the start of oxygen introduction, ventilation of the oxygen-containing gas was stopped, 50% aqueous solution in which 1.30 g of ethylenediaminetetraacetic acid tripotassium salt (a reagent made by Dojindo Molecular Technologies, Inc.) had been dissolved was added to this polymerization mixture. Next, 1.62 g of hydroquinone (a reagent made by Wako Pure Chemical Industries, Ltd.) was added little by little to react them at 45° C. for one hour until the slurry polyphenylene ether became white. After the reaction, the polyphenylene ether was filtered and washed three times with a methanol lavage fluid (b), in which the mass ratio (b/a) of the lavage fluid (b) to the washed polyphenylene ether (a) was 4, to obtain a wet polyphenylene ether. Next, the wet polyphenylene ether was subject to vacuum drying at 120° C. for one hour to obtain a dry polyphenylene ether (polymer (A1)).

The weight-average molecular weight of the obtained polymer (A1) was 3,940, its number average molecular weight was 2,190, and its glass transition temperature was 150° C.

(Synthesis of Thermoplastic Elastomer 1)

18.2 parts by mass of a hydrogenated polybutadiene resin having a hydroxy group at both ends (GI-3000 by Nippon Soda Co., Ltd.), 3.16 parts by mass of diphenylmethane diisocyanate, and 31.6 parts by mass of toluene were added in a flask to stir and dissolve them. Next, 0.12 parts by mass of triethylamine was added as the catalyst to heat them to 70° C. and react them for one hour to obtain a polymer (B1) (both-end isocyanated hydrogenated polybutadiene). The weight-average molecular weight of the obtained polymer (B1) was 5,328, its number average molecular weight was 4,417, and its glass transition temperature was −35° C.

And then, the polymer (A1) and the polymer (B1) were copolymerized by dropping a solution in which 15.4 parts by mass of the polymer (A1) had been dissolved in 31.6 parts by mass of toluene and further heating them at 70° C. for two hours to obtain a thermoplastic elastomer. The molar ratio at the time of the copolymerization was the polymer (A1):the polymer (B1)=1:1.

The obtained thermoplastic elastomer was reprecipitated in ethanol, and then, a thermoplastic elastomer 1 was retrieved by vacuum drying. The weight-average molecular weight of the thermoplastic elastomer 1 was 36,700, and its number average molecular weight was 17,900.

The glass transition temperature was measured using this thermoplastic elastomer 1. The obtained thermoplastic elastomer 1 primarily included an A1-B1-A1 copolymer in which the block structural unit derived from the polymer (A1) and the block structural unit derived from the polymer (B1) were alternately arrayed, with 95 parts by mass or more of the A1-B1-A1 copolymer.

(Production of Molded Product)

The aforementioned thermoplastic elastomer was kneaded using a compounder (Xplore MC15 made by Rheo Lab Ltd.) at 210° C. for three minutes in a nitrogen atmosphere by rotating the screw at 100 rpm. After the kneading, the melted resin was casted in an ISO37 type 2 mold, which was kept at 50° C., and held for 40 seconds to produce a small specimen. The tensile test was conducted using this specimen. Table 1 represents the results.

### Example 2

The tensile test was conducted by producing a thermoplastic elastomer 2 and a molded product similarly to Example 1 except for using a polymer (B2) (both-end isocyanated hydrogenated polybutadiene, with a weight-average molecular weight of 5328, a number average molecular weight of 4417, and a glass transition temperature of −35° C.). The polymer (B2) was obtained similarly to Example 1 except that the usage of the polymer (A1) used at the time of the thermoplastic elastomer synthesis was set to 12.2 parts by mass, and the usage of hydrogenated polybutadiene having a hydroxy group at both ends was set to 21.4 parts by mass and the usage of diphenylmethane diisocyanate was set to 3.65 parts by mass as the polymer B. The weight-average molecular weight of the thermoplastic elastomer 2 was 33900, and its number average molecular weight was 15800.

The obtained thermoplastic elastomer 2 primarily included an A1-B2-A1 copolymer in which the block structural unit derived from the polymer A1 and the block structural unit derived from the polymer B2 were alternately arrayed, with 90 parts by mass or more of the

A1-B2-A1 copolymer.

The molar ratio at the time of the copolymerization was the polymer (A1): the polymer (B2)=1:2.

### Example 3

The tensile test was conducted by producing a thermoplastic elastomer 3 and a molded product similarly to Example 1 except for using a polymer (B3) (both-end isocyanated hydrogenated polybutadiene, with a weight-average molecular weight of 5328, a number average molecular weight of 4417, and a glass transition temperature of −35° C.). The polymer (B3) was obtained similarly to Example 1 except that the usage of the polymer (A1) used at the time of the thermoplastic elastomer synthesis was set to 17.4 parts by mass, and the usage of hydrogenated polybutadiene having a hydroxy group at both ends was set to 16.2 parts by mass and the usage of diphenylmethane diisocyanate was set to 2.81 parts by mass as the polymer B. The weight-average molecular weight of the thermoplastic elastomer 3 was 34200, and its number average molecular weight was 14900.

The obtained thermoplastic elastomer 3 primarily included an A1-B3-A1 copolymer in which the block structural unit derived from the polymer A1 and the block structural unit derived from the polymer B3 were alternately arrayed, with 80 parts by mass or more of the A1-B3-A1 copolymer.

The molar ratio at the time of the copolymerization was the polymer (A1): the polymer (B3)=2:1.

### Example 4

(Synthesis of Thermoplastic Elastomer)

11.8 parts by mass of the polymer (A1), 1.73 parts by mass of tolylene diisocyanate, and 26.7 parts by mass of toluene were added in a flask to stir and dissolve them. Next, 6.00 parts by mass of dibutyltin dilaurate was added as the catalyst to react them at the room temperature for ten minutes to obtain a polymer (A2) (both-end isocyanated polymer). The weight-average molecular weight of the obtained polymer (A2) was 5,940, its number average molecular weight was 3,190, and its glass transition temperature was 149° C.

And then, the polymer (A2) and a polymer (B4) were copolymerized by dropping a solution in which 17.8 parts by mass of the polymer (B4) (hydrogenated polybutadiene resin B4 having a hydroxy group at both ends, GI-3000 by Nippon Soda Co., Ltd., with a weight-average molecular weight of 5085, a number average molecular weight of 4123, and a glass transition temperature of −35° C.) had been dissolved in 35.9 parts by mass of toluene and further heating them at 50° C. for six hours to obtain a thermoplastic elastomer 4. The molar ratio at the time of the copolymerization was the polymer (A2):the polymer (B4)=1:1.

The obtained thermoplastic elastomer was reprecipitated in ethanol, and then, the thermoplastic elastomer 4 was retrieved by vacuum drying. The weight-average molecular weight of the thermoplastic elastomer 4 was 48,800, and its number average molecular weight was 18,700.

The obtained thermoplastic elastomer 4 primarily included an A2-B4-A2 copolymer in which the block structural unit derived from the polymer (A2) and the block structural unit derived from the polymer (B4) were alternately arrayed, with 95 parts by mass or more of the A2-B4-A2 copolymer.

A molded product was produced similarly to Example 1, using the obtained thermoplastic elastomer 4.

### Example 5

### (Synthesis of Polymer (A3))

In a 1.5-liter jacketed reactor equipped with a sparger for oxygen-containing gas introduction, a stirring turbine impeller, and a baffle at the reactor bottom, and a reflux condenser at a vent gas line of the reactor upper part, 0.2512 g of cupric chloride dihydrate, 1.1062 g of 35% hydrochloric acid, 9.5937 g of N,N,N′,N′-tetramethylpropanediamine, 71.0 g of n-butanol and 638.0 g of methanol, and 180.0 g of 2,6-dimethylphenol were added. The composition mass ratio of the used solvent was n-butanol:methanol=10:90. Next, at the same time as beginning to introduce oxygen into the reactor from the sparger at a rate of 180 mL/min while vigorously stirring it, the heating medium was passed through the jacket so as to keep the polymerization temperature at 45° C. for adjustment. The polymerization solution gradually took on the appearance of a slurry.

120 minutes later from the start of oxygen introduction, ventilation of the oxygen-containing gas was stopped, 50% aqueous solution in which 1.30 g of ethylenediaminetetraacetic acid tripotassium salt (a reagent made by Dojindo Molecular Technologies, Inc.) had been dissolved was added to this polymerization mixture. Next, 1.62 g of hydroquinone (a reagent made by Wako Pure Chemical Industries, Ltd.) was added little by little to react them at 45° C. for one hour until the slurry polyphenylene ether became white. After the reaction, the polyphenylene ether was filtered and washed three times with a methanol lavage fluid (b), in which the mass ratio (b/a) of the lavage fluid (b) to the washed polyphenylene ether (a) was 4, to obtain a wet polyphenylene ether. Next, the wet polyphenylene ether was subject to vacuum drying at 120° C. for one hour to obtain a dry polyphenylene ether (polymer (A3)).

The weight-average molecular weight of the obtained polymer (A3) polyphenylene ether was 2,890, its number average molecular weight was 1,510, and its glass transition temperature was 149° C.

(Synthesis of Thermoplastic Elastomer)

12.8 parts by mass of the polymer (B4) (a hydrogenated polybutadiene resin having a hydroxy group at both ends, GI-3000 by Nippon Soda Co., Ltd.), 2.13 parts by mass of diphenylmethane diisocyanate, and 35.5 parts by mass of toluene were added in a flask to stir and dissolve them. Next, 0.12 parts by mass of triethylamine was added as the catalyst to heat them to 70° C. and react them for one hour to obtain a polymer (B5) (both-end isocyanated hydrogenated polybutadiene). The weight-average molecular weight of the obtained polymer (B5) was 5,328, its number average molecular weight was 4,417, and its glass transition temperature was −35° C.

And then, the polymer (A3) and the polymer (B5) were copolymerized by dropping a solution in which 13.4 parts by mass of the polymer (A3) had been dissolved in 35.03 parts by mass of toluene and further heating them at 70° C. for two hours to obtain a thermoplastic elastomer. The molar ratio at the time of the copolymerization was the polymer (A3):the polymer (B5)=2:1.

The obtained thermoplastic elastomer 5 was reprecipitated in ethanol, and then, the thermoplastic elastomer was retrieved by vacuum drying. The weight-average molecular weight of the thermoplastic elastomer 5 was 13,870, and its number average molecular weight was 6,470. The obtained thermoplastic elastomer primarily included an A3-B5-A3 copolymer with 95 parts by mass or more of the A3-B5-A3 copolymer.

The glass transition temperature was measured using this thermoplastic elastomer.

(Production of Molded Product)

The aforementioned thermoplastic elastomer was kneaded using a compounder (Xplore MC15 made by Rheo Lab Ltd.) at 210° C. for five minutes in a nitrogen atmosphere by rotating the screw at 100 rpm. After the kneading, the melted resin was casted in an ISO37 type 2 mold, which was kept at 50° C., and held for 40 seconds to produce a small specimen. The tensile test was evaluated using this specimen. Table 1 represents the results.

### Example 6

The tensile test was evaluated by producing a thermoplastic elastomer 6 and a molded product similarly to Example 1 except for using a polymer (B6) (both-end isocyanated hydrogenated polybutadiene, with a weight-average molecular weight of 5328, a number average molecular weight of 4417, and a glass transition temperature of −35° C.). The polymer (B6) was obtained similarly to Example 1 except that the usage of the polymer (A3) used at the time of the thermoplastic elastomer synthesis was set to 14.1 parts by mass, and the usage of a hydrogenated polybutadiene resin having a hydroxy group at both ends was set to 19.7 parts by mass and the usage of diphenylmethane diisocyanate was set to 2.52 parts by mass as the polymer B.

The molar ratio at the time of the copolymerization was the polymer A3:the polymer B6=3:2.

The obtained thermoplastic elastomer 6 primarily included an A3-B6-A3 copolymer with 80 parts by mass or more of the A3-B6-A3 copolymer. The weight-average molecular weight of the thermoplastic elastomer 6 was 12330, and its number average molecular weight was 6250.

### Example 7

The tensile test was evaluated by producing a thermoplastic elastomer and a molded product similarly to Example 1 except for using a polymer (B7) (both-end isocyanated hydrogenated polybutadiene, with a weight-average molecular weight of 5328, a number average molecular weight of 4417, and a glass transition temperature of −35° C.). The polymer (B7) was obtained similarly to Example 1 except that the usage of the polymer (A3) used at the time of the thermoplastic elastomer synthesis was set to 11.3 parts by mass, and the usage of a hydrogenated polybutadiene B3 having an isocyanate group at both ends was set to 19.0 parts by mass, and the usage of diphenylmethane diisocyanate was set to 1.88 parts by mass.

The molar ratio at the time of the copolymerization was the polymer (A3):the polymer (B7)=5:4.

The obtained thermoplastic elastomer 7 primarily included an A3-B7-A3 copolymer with 70 parts by mass or more of the A3-B7-A3 copolymer.

The weight-average molecular weight of the thermoplastic elastomer 7 was 11500, and its number average molecular weight was 6060.

### Example 8

### (Synthesis of Thermoplastic Elastomer)

15.9 parts by mass of the polymer (A3), 1.84 parts by mass of tolylene diisocyanate, and 31.9 parts by mass of toluene were added in a flask to stir and dissolve them. Next, 6.66 parts by mass of dibutyltin dilaurate was added as the catalyst to react them at the room temperature for ten minutes to obtain a polymer (A4) (both-end isocyanated polymer). The weight-average molecular weight of the obtained polymer (A4) was 3,890, its number average molecular weight was 2,510, and its glass transition temperature was 149° C.

And then, the polymer (A4) and the polymer (B4) were copolymerized by dropping a solution in which 15.8 parts by mass of the polymer (B4) (a hydrogenated polybutadiene resin having a hydroxy group at both ends, GI-3000 by Nippon Soda Co., Ltd.) had been dissolved in 27.9 parts by mass of toluene and further heating them at 50° C. for six hours to obtain a thermoplastic elastomer 8. The molar ratio at the time of the copolymerization was the polymer (A4):the polymer (B4)=2:1.

The obtained thermoplastic elastomer 8 primarily included an A4-B4-A4 copolymer with 95 parts by mass or more of the A4-B4-A4 copolymer. The weight-average molecular weight of the thermoplastic elastomer 8 was 14270, and its number average molecular weight was 6530.

### Comparative Example 1

The evaluation and test were conducted with only the polymer (A1). In the tensile test, the product was unmeasurably fragile and had a value of the measurement limit or less.

### Comparative Example 2

A molded product was produced similarly to Example 1 by adding 50 parts by mass of a hydrogenated styrene-based thermoplastic elastomer (H1041 made by Asahi Kasei Corp.) instead of the polymer B to 50 parts by mass of the polymer (A1).

### Comparative Example 3

16.6 parts by mass of the hydrogenated polybutadiene resin B4 having a hydroxy group at both ends (GI-3000 by Nippon Soda Co., Ltd.), 2.80 parts by mass of diphenylmethane diisocyanate, and 33.2 parts by mass of toluene were added in a flask to stir and dissolve them. Next, 0.07 parts by mass of triethylamine was added as the catalyst. The polymer (A1) and the polymer (B4) were randomly copolymerized by adding a solution in which 33.2 parts by mass of the polymer (A1) had been dissolved in part by mass of toluene and further heating them at 70° C. for six hours to obtain a thermoplastic elastomer. The molar ratio at the time of the copolymerization was the polymer (A1):the polymer (B4)=1:1.

The obtained thermoplastic elastomer was reprecipitated in ethanol, and then, the thermoplastic elastomer was retrieved by vacuum drying. Obtained. The weight-average molecular weight of the thermoplastic elastomer was 12,081, its number average molecular weight was 6,291, and its glass transition temperature was 149° C. Table 1 represents the results.

Table 1 represents the results of the amount, the tensile test, the glass transition temperature, and the transparency of the polymer (A) and the polymer (B) used in Examples 1 to 4, and 6 to 8 and Comparative Examples 1 to 3. For the transparency, visual evaluation was conducted using the aforementioned ISO37 type 2 molded piece produced by the method described in Example 1 or 5. The transparency was evaluated as “Good” when characters could be seen through the molded piece when the molded piece is viewed in the thickness direction, and “Poor” when characters could not be seen.

From Examples 1 to 8, it could be confirmed that the thermoplastic elastomer obtained from the polymer (A) and the polymer (B) keeps the elongation while exhibiting sufficiently high strength. It was also confirmed that any sample keeps high glass transition temperature and transparency.

| | | | | Exam- | Exam- | Exam- | Exam- | Exam- | Exam- |
|---|---|---|---|---|---|---|---|---|---|
| | | | | ple 1 | ple 2 | ple 3 | ple 4 | ple 5 | ple 6 |
| Raw | Polymer | Type | — | A1 | A1 | A1 | A2 | A3 | A3 |
| material | (A) | Mass ratio | part by mass | 42 | 37 | 52 | 40 | 51 | 42 |
| | | Mw | — | 3940 | 3940 | 3940 | 5940 | 2890 | 2890 |
| | | Mn | — | 2190 | 2190 | 2190 | 3190 | 1510 | 1510 |
| | | Glass transition | ° C. | 150 | 150 | 150 | 149 | 149 | 149 |
| | | temperature | | | | | | | |
| | Polymer | Type | — | B1 | B2 | B3 | B4 | B5 | B6 |
| | (B) | Mass ratio | part by mass | 58 | 63 | 48 | 60 | 49 | 58 |
| | | Mw | — | 5328 | 5328 | 5328 | 5085 | 5328 | 5328 |
| | | Mn | — | 4417 | 4417 | 4417 | 4123 | 4417 | 4417 |
| | | Glass transition | ° C. | −35 | −35 | −35 | −35 | −35 | −35 |
| | | temperature | | | | | | | |
| | Hydrogenated styrene-based | | part by mass | — | — | — | — | — | — |
| | thermoplastic elastomer | | | | | | | | |
| Evalu- | Thermo- | Mw | — | 36700 | 33900 | 34200 | 48800 | 13870 | 12330 |
| ation | plastic | Mn | — | 17900 | 15800 | 14900 | 18700 | 6470 | 6250 |
| | elastomer | Glass transition | ° C. | 149 | 148 | 149 | 149 | 149 | 148 |
| | | temperature | | | | | | | |
| | Tensile test | Maximum stress | MPa | 42 | 35 | 50 | 45 | 32 | 27 |
| | | Breaking strain | % | 500 | 600 | 300 | 550 | 350 | 400 |

| | | | | | | | |
|---|---|---|---|---|---|---|---|
| Transparency | — | Good | Good | Good | Good | Good | Good |

| | | | | | | Compar- | Compar- | Compar- |
|---|---|---|---|---|---|---|---|---|
| | | | | Exam- | Exam- | ative | ative | ative |
| | | | | ple 7 | ple 8 | Example 1 | Example 2 | Example 3 |
| Raw | Polymer | Type | — | A3 | A4 | A1 | A1 | A1 |
| material | (A) | Mass ratio | part by mass | 37 | 50 | 100 | 50 | 46 |
| | | Mw | — | 2890 | 3890 | 3940 | 3940 | 3940 |
| | | Mn | — | 1510 | 2510 | 2190 | 2190 | 2190 |
| | | Glass transition | ° C. | 149 | 149 | 150 | 150 | 150 |
| | | temperature | | | | | | |
| | Polymer | Type | — | B7 | B4 | — | — | B4 |
| | (B) | Mass ratio | part by mass | 63 | 50 | — | — | 54 |
| | | Mw | — | 5328 | 5085 | — | — | 5085 |
| | | Mn | — | 4417 | 4123 | — | — | 4123 |
| | | Glass transition | ° C. | −35 | −35 | — | — | −35 |
| | | temperature | | | | | | |
| | Hydrogenated styrene-based | | part by mass | — | — | — | 50 | — |
| | thermoplastic elastomer | | | | | | | |
| Evalu- | Thermo- | Mw | — | 11500 | 14270 | 3940 | — | 12081 |
| ation | plastic | Mn | — | 6060 | 6530 | 2190 | — | 6291 |
| | elastomer | Glass transition | ° C. | 149 | 149 | 155 | 118 | 149 |
| | | temperature | | | | | | |
| | Tensile test | Maximum stress | MPa | 23 | 40 | Unmea- | 30 | 20 |
| | | | | | | surable | | |
| | | Breaking strain | % | 470 | 400 | Unmea- | 200 | 110 |
| | | | | | | surable | | |

| | | | | | | |
|---|---|---|---|---|---|---|
| Transparency | — | Good | Good | Poor | Poor | Poor |

### INDUSTRIAL APPLICABILITY

The molded product of this disclosure is excellent in heat resistance, rubber properties, transparency, etc., and can be preferably used in a wide range of areas such as automobile interior components and enclosures of the home electric appliances.

1. A thermoplastic elastomer primarily comprising a copolymer including a block structural unit derived from a polymer (A) that contains a polyphenylene ether and has a glass transition temperature of 120° C. or more, and a block structural unit derived from a polymer (B) that primarily contains a diene rubber and has a glass transition temperature of 20° C. or less.

2. The thermoplastic elastomer according to claim 1, wherein the copolymer is an ABA copolymer having a block array structure of the block structural unit derived from the polymer (A), the block structural unit derived from the polymer (B), and the block structural unit derived from the polymer (A).

3. The thermoplastic elastomer according to claim 1, wherein the copolymer has a block array structure in which the block structural unit derived from the polymer (A) and the block structural unit derived from the polymer (B) are alternately arrayed.

4. The thermoplastic elastomer according to claim 1, wherein the polymer (A) is a polyphenylene ether having a phenolic hydroxyl group at one end.

5. The thermoplastic elastomer according to claim 1, wherein the polymer (A) is a polyphenylene ether having a phenolic hydroxyl group at both ends.

6. The thermoplastic elastomer according to claim 1, wherein the polymer (A) is a polyphenylene ether having an isocyanate group at both ends.

7. The thermoplastic elastomer according to claim 1, wherein the polymer (B) is a diene rubber having an isocyanate group at both ends.

8. The thermoplastic elastomer according to claim 1, wherein the diene rubber is a hydrogenated polybutadiene rubber.

9. The thermoplastic elastomer according to claim 1, wherein the copolymer is a copolymer in which the block structural unit derived from the polymer (A) is bonded to the block structural unit derived from the polymer (B) via a urethane bond.

10. A thermoplastic elastomer resin composition comprising the thermoplastic elastomer according to claim 1.

11. A molded product comprising the thermoplastic elastomer resin composition according to claim 10.
